(19) United States
(12) Patent Application Publication
(10) Pub. No.: US 2009/0027917 A1
(43) Pub. Date: Jan. 29, 2009

(54) OPTICAL FIBER INDICATOR LIGHT

(75) Inventors: Jui-Lin CHEN, Taipei City (TW); Ho-Wen Kuo, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/781,786

(22) Filed: Jul. 23, 2007

(51) Int. Cl. G02B 6/00

(52) U.S. Cl. 362/582; 362/551

(57) ABSTRACT

The optical fiber indicator light includes a lighting device, an optical fiber and an optical guiding structure. The optical fiber has a first optical fiber point a second optical fiber point. The first optical fiber point is abutted on the lighting device and the second optical fiber point is opposed against the first optical fiber point. The optical guiding structure has a lens, a passage, and an air chamber connected with the passage. The air chamber is located behind the lens. A portion of the optical fiber is contained in the passage, and the second optical fiber point is placed in the air chamber. Light emitted from the optical fiber may be diffused by the air chamber to enlarge visible area of the optical fiber.

### BACKGROUND

1. Field of Invention

The present invention relates to an optical fiber indicator light. More particularly, the present invention relates to an optical guiding structure of the optical fiber indicator light.

2. Description of Related Art

Information technology and the computer industry are highly developed now. People rely heavily on computer systems. The number of peripherals of computers has also highly increased. For example, hard disk drives, floppy disk drives, and optical disk drives are widely used in computers. The hard disk drive is an important data storage device of the peripherals. Increasingly, computers have at least two hard disk drivers installed. Thus, an indicator light is needed to indicate each hard disk drive individually. In order to remove or assemble the hard disk drive easily, each hard disk drive is placed on a hard disk bracket, and the indicator lights are disposed near the hard disk drive respectively.

The conventional indicator light for the hard disk drive includes an optical fiber and an optical guiding structure. The light source of the optical fiber may be a laser diode or a light-emitting diode (LED). However, a light diffused angle of the optical fiber is so small that the visible area of the optical fiber is limited.

Thus, there is a need for enlarging the visible area of the optical fiber in the indicator light.

### SUMMARY

As embodied and broadly described herein, the present invention provides an optical fiber indicator light. The optical fiber indicator light includes a lighting device, an optical fiber and an optical guiding structure. The optical fiber has a first optical fiber point a second optical fiber point. The first optical fiber point is abutted on the lighting device and the second optical fiber point is opposed against the first optical fiber point. The optical guiding structure has a lens, a passage, and an air chamber connected with the passage. The air chamber is located behind the lens. A portion of the optical fiber is contained in the passage, and the second optical fiber point is placed in the air chamber The invention also provides an optical guiding structure for guiding a light emitted from an optical fiber. The optical guiding structure includes a lens having an emitting surface, a passage, and an air chamber. The air chamber is located behind the lens. The passage is disposed at a side opposite the emitting surface in the optical guiding structure and is connected with the air chamber. A portion of the optical fiber is contained in the passage. The optical fiber indicator light may use the air chamber disposed in the optical guiding structure to diffuse the light emitted from the optical fiber, thus the visible area of the optical fiber indicator light may be enlarged.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of an embodiment of an optical fiber indicator light of the invention; and

FIG. 2 is a schematic diagram of another embodiment of the optical fiber indicator light of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

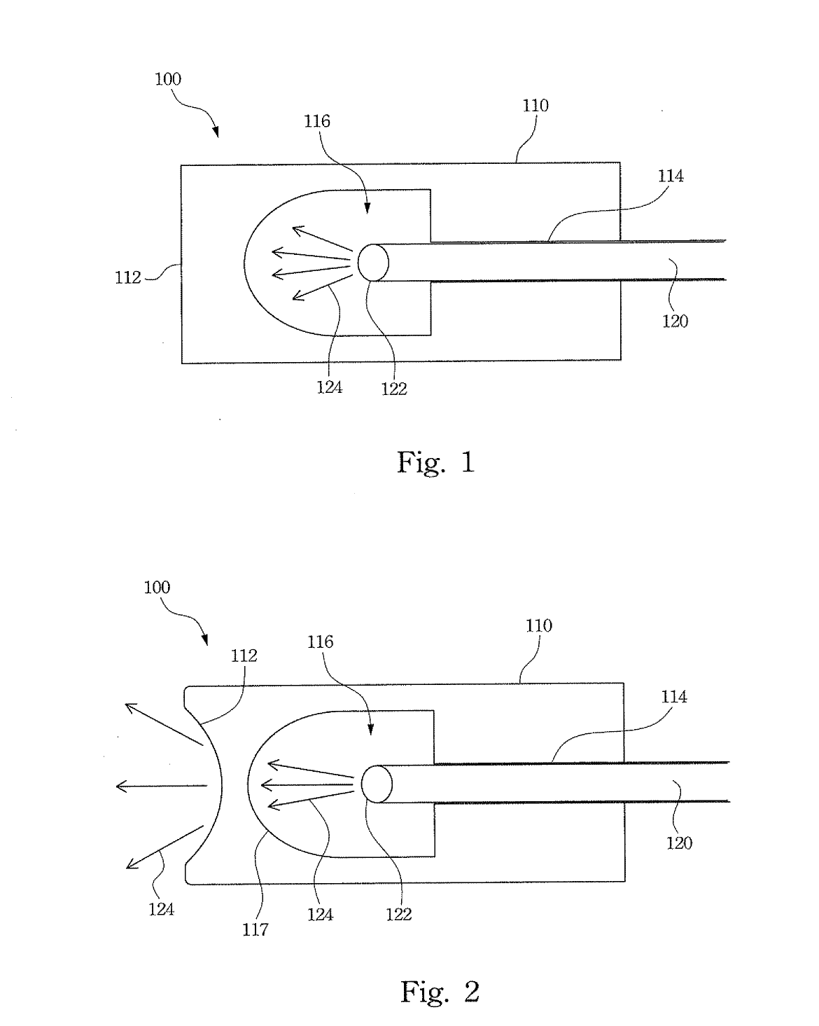

Refer to FIG. 1. FIG. 1 illustrates a schematic diagram of an embodiment of an optical fiber indicator light of the invention. An optical fiber indicator light 100 includes a lighting device (not shown), an optical guiding structure 110, and an optical fiber 120. The optical fiber indicator light 100 may be installed in a computer or a server as an indicator light for peripherals such as a hard disk drive. The optical guiding structure 110 may guide the optical fiber 120 and transmit a light 124 emitted from the optical fiber 120. The optical guiding structure 110 includes a lens having an emitting surface 112, a passage 114, and an air chamber 116. The air chamber 116 is located behind the lens. The passage 114 is disposed at a side opposite to the emitting surface 112 in the optical guiding structure 100. The air chamber 116 is connected to the passage 116. The emitting surface 112 is opposing to a side of the lens facing the air chamber 116 of the optical guiding structure 110. The optical fiber 120 has a first optical fiber point (not shown) and a second optical fiber point 122 opposed against the first optical fiber point. The first optical fiber point is abutted on the lighting device, such as a laser diode or a light-emitting diode (LED). A portion of the optical fiber 120 is contained in the passage 116. The second optical fiber point 122 is placed in the air chamber 116. The light 124 emitted from the second optical fiber point 1 22 can be diffused by taking an air in the air chamber 116 as a medium. Thus, a visible area of the light 124 from the second optical fiber point 122 can be enlarged. A material of the optical guiding structure 110 could be a limpid resin. The lens can be a plano-concave lens and the emitting surface 112 is a plane.

Refer to FIG. 2. FIG. 2 illustrates a schematic diagram of another embodiment of the optical fiber indicator light of the invention. The lens of the optical guiding structure 110 can be a biconcave lens. The air chamber 116 is curved to the emitting surface 112 to form a concave surface 117 facing the air chamber 116 in the optical guiding structure 110 of the optical fiber light 100. The light 124 emitted from the optical fiber 120 can be diffused through the biconcave lens of the optical guiding structure 110, and the visible area of the light 124 emitted from the second optical fiber point 122 may be enlarged.

Different arc shapes of the concave surface 117 can alter a diffused angle of the light 124. The emitting surface 112 of the optical guiding structure 110 can be a hollow surface. The hollow surface of the emitting surface 112 is sunken to the air chamber 116 to form the biconcave lens at the front side of the optical guiding structure 110. The diffused angle of the light 124 of the optical fiber indicator light 100 may be enlarged by the biconcave lens of the optical guiding structure 110.

The optical fiber indicator light may use the air chamber disposed in the optical guiding structure to diffuse the light emitted from the optical fiber, thus the visible area of the optical fiber indicator light may be enlarged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical fiber indicator light comprising:
a lighting device;
an optical fiber having a first optical fiber point abutted on the lighting device and a second optical fiber point opposed against the first optical fiber point; and
an optical guiding structure having a lens, a passage and an air chamber, wherein the air chamber is located behind the lens, the passage is connected with the air chamber, a portion of the optical fiber is contained in the passage, the second optical fiber point is placed in the air chamber.

2. The optical fiber indicator light of claim 1, wherein the lens comprises an emitting surface, the emitting surface opposing to a side of the lens facing the air chamber of the optical guiding structure.

3. The optical fiber indicator light of claim 2, wherein the lens is a biconcave lens, the emitting surface is a hollow surface.

4. The optical fiber indicator light of claim 2, wherein the lens is a plano-concave lens and the emitting surface is plane

5. The optical fiber indicator light of claim 1, wherein a material of the optical guiding structure is a limpid resin.

6. The optical fiber indicator light of claim 1, wherein the optical fiber indictor light is a hard disk indicator light.

7. An optical guiding structure for guiding a light emitted from an optical fiber comprising:
a lens having an emitting surface;
a air chamber located behind the lens; and
a passage connected with the air chamber, wherein a portion of the optical fiber is contained in the passage.

8. The optical guiding structure of claim 7, wherein the lens is a biconcave lens, the emitting surface is a hollow surface.

9. The optical guiding structure of claim 7, wherein the lens is a plano-concave lens and the emitting surface is plane.

10. The optical guiding structure of claim 7, wherein a material of the optical guiding structure is a limpid resin.
